(19) United States
(12) Patent Application Publication
(10) Pub. No.: US 2014/0122177 A1
(43) Pub. Date: May 1, 2014

(54) ELECTRIC POWER DEMAND RESPONSE SYSTEM AND METHOD

(71) Applicants: State Grid Energy Research Institute, Beijing (CN); State Grid Corporation of China, Beijing (CN)

(72) Inventors: Loi Lei Lai, Beijing (CN); Fangyuan Xu, Beijing (CN)

(73) Assignees: State Grid Corporation of China, Beijing (CN); State Grid Energy Research Institute, Beijing (CN)

(21) Appl. No.: 13/891,896

(22) Filed: May 10, 2013

(30) Foreign Application Priority Data
Oct. 25, 2012 (CN) 201210414791.3

(51) Int. Cl. G06Q 30/02

(52) U.S. Cl. CPC G06Q 30/0206
USPC 705/7.31

(57) ABSTRACT

The present invention provides an electric power demand response system and method. The system includes an agent group including at least one agent, a total load calculation module and an electricity price calculation module; wherein each agent is adapted to receive electricity price data output by the electricity price calculation module and simulate electricity consumption behavior of a user under the effect of the electricity price, and output load data of the user; the total load calculation module is adapted to receive load data output by all the agents in the agent group and thereby calculate a total load of the agent group; and the electricity price calculation module is adapted to receive the total load of the agent group calculated by the total load calculation module and receive policy data, and thereby calculate a proper electricity price data.

### FIELD OF THE INVENTION

The present invention relates to the field of customer behavior analysis in electric power system, and particularly relates to a demand response (customer response) system and the associated methods.

### BACKGROUND OF THE INVENTION

An agent based demand response system needs to simulate specific users' behavior. Each user in the system is represented by a data structure referred to as an agent. In the agent, attributes of the user himself and various kinds of electrical equipments are referred to as members in the data structure. The agent based method can describe microscopically the user behavior and thereby form various macroscopic statistical characteristics, so that the demand response system can be described both microscopically and macroscopically at the same time.

In the prior art, demand responses from several standard electricity pricing schemes are mainly concerned. Those standard electricity pricing schemes include a time-of-use electricity price, a critical peak electricity price and a real time electricity price, as well as static price. In the prior art, each user is treated as an agent and the effect of electricity price on the user behavior of each agent is studied in the case when one or several kinds of the electricity prices are selected. Load of each agent is calculated corresponding to the agent's attribute and the selected pricing scheme and thereby the total load of a group of the agents could be calculated.

However, the prior art only considers the effect of the electricity price on the user behavior and the effect of the user behavior on the user load, therefore, the whole analysis process is an open-loop process which ignores the reverse action of the user load on the electricity price.

On the other hand, the existing patents in electric power demand response place their emphasis on a centralized appliance control framework that smart meter is selected as the controller, please see the US Patent, ‘Electronic smart meter enabling demand response and method for demand response’, Pub. No. US 2009/0198384, Pub. Date. Aug 6, 2009, and the EU Patent, ‘Demand response system for control of electric consumers’, Application No. 11156116.3, Date: Feb. 2, 2011. In those cases, appliances are controlled by smart meter with preset rules instead of controlled by human itself. Those cases may be popular in decades later but at present, the most cases appear to be that appliances are controlled by customers' behavior directly, which is concerned in this patent application. Moreover, the present patents are providing a scheme for an individual customer unit but this patent application provides analysis on statistical result of a group of customers.

### SUMMARY OF THE INVENTION

The object of the present invention is to provide a demand response system and its associated method which can achieve a closed-loop analysis process in consideration of mutual influence between an electricity price and a user load.

In one aspect of the invention, there is a demand response system, including that:

an agent group including at least one agent, a total load calculation module and an electricity price calculation module;

wherein each agent is adapted to receive electricity price data output from the electricity price calculation module and to simulate electricity consumption behavior under the impact from the electricity price. The output of each agent is the load data of the agent.

the total load calculation module is adapted to receive load data output by all the agents in the agent group and thereby calculate a total load of the agent group; and

the electricity price calculation module is adapted to receive the total load of the agent group calculated by the total load calculation module and the policy data, and thereby calculate a proper electricity price data.

Preferably, the system further includes an average daily load per agent calculation module which receives the total load data from the agent group calculated by the total load calculation module. The average daily load per agent calculation module calculates average daily load data per agent according to the number of the agents in the agent group.

Preferably, the system further includes an average daily electricity cost per agent calculation module which receives the total load data of the agent group calculated from the total load calculation module and the electricity price data calculated from the electricity price calculation module. The average daily electricity cost per agent calculation module calculates average daily electricity cost per agent according to the number of the agents in the agent group.

Preferably, the agent is further adapted to calculate satisfaction degree of each agent; and

the system further includes an overall user satisfaction degree calculation module which receives the satisfaction degree data calculated from all the agents in the agent group and thereby calculates an overall user satisfaction degree for the agent group.

In another aspect of the invention, an electric power demand response method is further provided, including that

each agent in an agent group simulates its electricity consumption behavior under the impact from an electricity price according to the electricity price data. Each agent will also output load data of each user;

calculating total load of the agent group according to load data output by all the agents in the agent group; and

calculating a proper electricity price data according to the total load of the agent group and policy data. Each agent in the agent group will receive the calculated electricity price data.

Preferably, the method further includes:

calculation of average daily load data per agent according to the total load data of the agent group and the number of the agents in the agent group.

Preferably, the method further includes:

calculation of average daily electricity cost per agent according to the total load data of the agent group, the electricity price data and the number of the agents in the agent group.

Preferably, the method further includes:

calculation of satisfaction degree data by each agent in the agent group, for each user; and

calculation of an overall user satisfaction degree for the agent group according to the satisfaction degree data calculated by each agent in the agent group.

In the demand response system and its methods provided by this invention, the alternation of user's behavior is simulated in each agent with price data from electricity price calculation module. Moreover the electricity price data is calculated by the electricity price calculation module according to the total agent load and the electricity pricing policy. Thereby the whole analysis process is a closed-loop process in consideration of mutual influence between the electricity price and the user load. This consideration of the reverse impact from user load on electricity price can simulate the authentic operation in practice, revealing the interaction between utilities and electric customers more accurately. With the simulation from this closed-loop process, utilities can formulate more rational pricing scheme to optimize electricity consumption patterns and grid operations, as well as for better power system planning.

### BRIEF DESCRIPTION OF THE DRAWINGS

FIG. 1 is a schematic diagram of the demand response system according to the present invention.

### DETAILED DESCRIPTION OF THE INVENTION

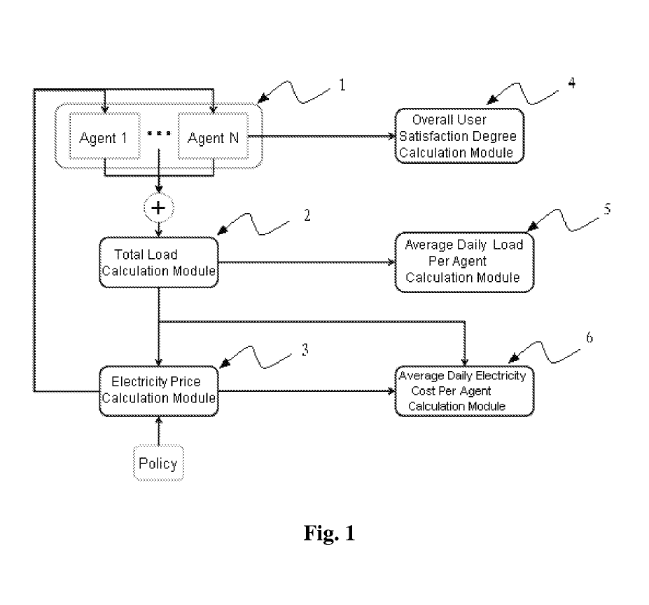

FIG. 1 shows schematic diagram of the demand response system according to the present invention. As shown in FIG. 1, the demand response system includes at least an agent group 1, a total load calculation module and an electricity price calculation module.

The agent group 1 includes at least one agent. By way of example, there are specifically N agents in FIG. 1, denoted as Agent 1 to Agent N respectively. Each agent represents a user and can simulate electricity consumption behavior of the user.

Specifically, each agent is adapted to receive electricity price data from the electricity price calculation module 3 and simulate user behavior under the impact of the electricity price. The output of each agent is load data of each user.

The total load calculation module 2 receives load data output by all the agents in the agent group 1 and thereby calculates total load of the agent group 1.

The electricity price calculation module 3 receives the total load data of the agent group 1 calculated by the total load calculation module 2 and receives policy data, and thereby calculates proper electricity price data. In the present invention, the electricity price calculation module 3 calculates the electricity price data by using a dynamic electricity price calculation method. Compared to the traditional static electricity price, the dynamic electricity price (including the time-of-use electricity price, the critical peak electricity price and the real time electricity price) varies with changes in the load and the policy requirement. Therefore, when the electricity price calculation module 3 simulates a variety of dynamic electricity price, the load data and the policy data are needed as inputs, to establish a mapping relationship between the inputs and the electricity price. For the time-of-use electricity pricing scheme and the critical peak electricity pricing scheme, a typical electricity price calculation method, a load threshold is set according to the total load data, and the change in the price around the threshold is set according to the policy data. For the real time electricity price, in a typical electricity price calculation method, a ratio to the electricity price is established according to the total load data, and the ratio is adjusted according to the policy data.

Therefore, in the electric power demand response system according to the embodiment of the invention, the change in the user behavior of the user depending on the electricity price calculated by the electricity price calculation module is simulated by the agent, moreover the electricity price is calculated by the electricity price calculation module according to the user load and the electricity pricing policy, thereby the whole analysis process is a closed-loop process in consideration of mutual influence between the electricity price and the user load.

In addition, in the electric power demand response system shown in FIG. 1, preferably there may be added an average daily load per agent calculation module 5 adapted to receive the total load data of the agent group calculated by the total load calculation module 2 and calculate average daily load data per agent according to the number of the agents in the agent group, so as to use the average daily load data per agent as one of the indicators for measuring the user behavior of the whole society.

Furthermore, there may also be added an average daily electricity cost per agent calculation module 6 adapted to receive the total load data of the agent group 1 calculated by the total load calculation module 2 and the electricity price data calculated by the electricity price calculation module 3 and calculate average daily electricity cost per agent according to the number of the agents in the agent group, so as to evaluate the effect of this kind of electricity price on members of the society and on the overall livelihood of the people.

In addition, when each agent in the agent group 1 simulates the electricity consumption behavior of the user under the effect of the electricity price, the agent can further calculate satisfaction degree for the user, and satisfaction degree is often important data in the simulation of the electricity consumption behavior of the process. Based on this, preferably, the agent calculates satisfaction degree for the user, and there is an overall user satisfaction degree calculation module 4 adapted to receive the satisfaction degree data calculated by all the agents in the agent group 1 and thereby calculates an overall user satisfaction degree of the agent group 1.

In addition, another embodiment of the present invention further provides an electric power demand response method, including:

Step 01: simulating, by each agent in an agent group, electricity consumption behavior of a user under an effect of an electricity price according to the electricity price data, and outputting load data of the user;

Step 02: calculating a total load of the agent group according to load data output by all the agents in the agent group; and

Step 03: calculating the proper electricity price data according to the total load of the agent group and policy data, and outputting the proper electricity price data to each agent in the agent group.

In addition, the method may further include: calculating average daily load data per agent according to the total load data of the agent group and the number of the agents in the agent group.

Furthermore, average daily electricity cost per agent may be calculated according to the total load data of the agent group and the electricity price data in combination with the number of the agents in the agent group.

Moreover, each agent in the agent group calculates satisfaction degree data for the electricity consumption behavior of the user; and an overall user satisfaction degree for the agent group is calculated according to the satisfaction degree data calculated by all the agents in the agent group.

Therefore, in the electric power demand response method according to the embodiment of the invention, the change in the user behavior of the user depending on the electricity price calculated by the electricity price calculation module is simulated by the agent, moreover the electricity price is calculated by the electricity price calculation module according to the user load and the electricity pricing policy, thereby the whole analysis process is a closed-loop process in consideration of mutual influence between the electricity price and the user load.

Those described above are only preferred embodiments of the present invention. It should be noted that a number of improvements and modifications may be made by the skilled in the art without deviation from the principle of the invention, and these improvements and modifications should also fall within the scope of protection of the present invention.

1. An electric power demand response system, comprising:
an agent group comprising at least one agent, a total load calculation module and an electricity price calculation module;
wherein each agent is adapted to receive electricity price data output by the electricity price calculation module and simulate electricity consumption behavior of a user under the effect of the electricity price, and output load data of the user,
the total load calculation module is adapted to receive load data output by all the agents in the agent group and thereby calculate a total load of the agent group; and
the electricity price calculation module is adapted to receive the total load of the agent group calculated by the total load calculation module and receive policy data, and thereby calculate the proper electricity price data;
wherein the above process performed by the agent, the total load calculation module, and the electricity price calculation module is a closed loop process.

2. The electric power demand response system according to claim 1, wherein the system further comprises an average daily load per agent calculation module adapt to receive the total load data of the agent group calculated by the total load calculation module and calculate average daily load data per agent according to the number of the agents in the agent group.

3. The electric power demand response system according to claim 1, wherein the system further comprises an average daily electricity cost per agent calculation module adapted to receive the total load data of the agent group calculated by the total load calculation module and the electricity price data calculated by the electricity price calculation module, and calculate average daily electricity cost per agent according to the number of the agents in the agent group.

4. The electric power demand response system according to claim 1, wherein the agent is further adapted to calculate satisfaction degree data for the electricity consumption behavior of the user; and
the system further comprises an overall user satisfaction degree calculation module adapted to receive the satisfaction degree data calculated by all the agents in the agent group, and thereby calculate an overall user satisfaction degree for the agent group.

5. An electric power demand response method, comprising:
simulating, by each agent in an agent group, electricity consumption behavior of each user under an effect of an electricity price according to the electricity price data, and outputting load data of the user;
calculating a total load of the agent group according to load data output by all the agents in the agent group; and
calculating a proper electricity price data according to the total load of the agent group and policy data, and outputting the proper electricity price data to each agent in the agent group.

6. The method according to claim 5, further comprising:
calculating average daily load data per agent according to the total load data of the agent group and the number of the agents in the agent group.

7. The method according to claim 5, further comprising:
calculating average daily electricity cost per agent according to the total load data of the agent group and the electricity price data in combination with the number of the agents in the agent group.

8. The method according to claim 5, further comprising:
calculating, by each agent in the agent group, satisfaction degree data for the electricity consumption behavior of the user; and
calculating an overall user satisfaction degree for the agent group according to the satisfaction degree data calculated by all the agents in the agent group.
